(19) United States
(12) Patent Application Publication
(10) Pub. No.: US 2002/0099662 A1
(43) Pub. Date: Jul. 25, 2002

(54) Method and system for providing a micropayment in a secure fashion utilizing a wireless device

(76) Inventor: Amit S. Joshi, Woodcliff Lake, NJ (US)

Correspondence Address: SAWYER LAW GROUP LLP, P.O. Box 51418, Palo Alto, CA, 94303, US

(21) Appl. No.: 09/766,141

(22) Filed: Jan. 19, 2001

(51) Int. Cl. G06F 17/60

(52) U.S. Cl. 705/64

(57) ABSTRACT

A method and system for providing a micropayment to a machine for providing goods or services utilizing a wireless device is disclosed. The method and system comprises selecting an item to be purchased from the machine by the wireless device and providing a code related to the item from the machine to the wireless device; transmitting a request including the code to a server and processing the request by server. The method and system further includes transmitting a response to the request to wireless device if the request is valid and transmitting the request to the machine. Finally, the method and system includes dispensing a product if the machine determines that response is valid based upon the code. Through the use of codebooks in the machine and the database and the use of a receiver/transmitter in the machine, a wireless device could be utilized advantageously to provide secure micropayments to the vending machine. This type of system would not require a significant expenditure or infrastructure and would not require a proprietary network for its implementation. Therefore, a system and method in accordance with the present invention would allow for an effective and efficient way to provide such secure micropayments.

### FIELD OF THE INVENTION

The present invention relates generally to a system and method for providing micropayments utilizing a wireless device and more particularly to a system and method for making such micropayments in a secure manner.

### BACKGROUND OF THE INVENTION

Vending machines are utilized extensively to provide goods such as sodas, cigarettes or other items for purchase. Typically, coins or the like are provided to the machines to ensure that the goods are purchased in an appropriate fashion. With the proliferation of wireless devices, it has become apparent that it is possible to utilize those wireless devices in the appropriate environment to provide a payment hereinafter referred to as a micropayment through such vending machines. However, one problem in utilizing such wireless devices for such transactions is that the system must be secure. One way of setting up a secure system to make such a micropayment is to provide a proprietary network of such vending machines that can interact exclusively with particular types of wireless devices. This type of network, however, does not lend itself to universal use of wireless devices with vending machines and also requires a costly infrastructure.

Accordingly, what is desired is a system and method that allows for wireless micropayments in a secure fashion that is easily implemented in machines. The system and method should be easy to implement, straightforward and inexpensive for existing machines. The present invention addresses such a need.

### SUMMARY OF THE INVENTION

A method and system for providing a micropayment to a machine for providing goods or services utilizing a wireless device is disclosed. The method and system comprises selecting an item to be purchased from the machine by the wireless device and providing a code related to the item from the machine to the wireless device; transmitting a request including the code to a server and processing the request by server. The method and system further includes transmitting a response to the request to wireless device if the request is valid and transmitting the request to the machine. Finally, the method and system includes dispensing a product if the machine determines that response is valid based upon the code.

Through the use of codebooks in the machine and the database and the use of a receiver/transmitter in the machine, a wireless device could be utilized advantageously to provide secure micropayments to the vending machine. This type of system would not require a significant expenditure or infrastructure and would not require a proprietary network for its implementation. Therefore, a system and method in accordance with the present invention would allow for an effective and efficient way to provide such secure micropayments.

### BRIEF DESCRIPTION OF THE DRAWINGS

FIG. 1 is a block diagram of a system in accordance with the present invention.

FIG. 2 is a flow chart of the operation of the system of FIG. 1 in accordance with the present invention.

### DETAILED DESCRIPTION

The present invention relates generally to a system and method for providing wireless micropayments and more particularly to a system and method for making such micropayments in a secure manner. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A system and method in accordance with the present invention provide a wireless micro-payment for goods or services which is secure. In a preferred embodiment, a one-time codebook is utilized in the system to facilitate a secure transation. To describe the features of the present invention, refer now to the following description in conjunction with the accompanying drawings.

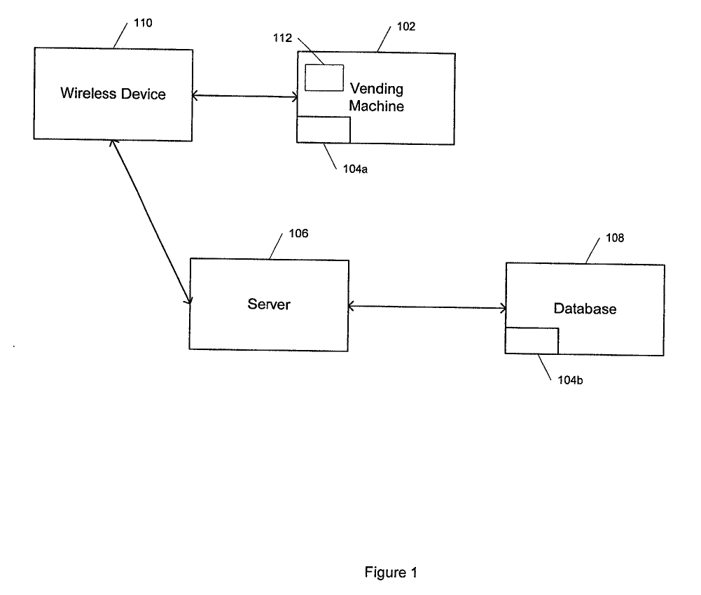

FIG. 1 is a block diagram of a system 100 in accordance with the present invention. The system 100 includes a vending machine 102 which contains goods to be purchased. A codebook 104a is included in the machine 102. In a preferred embodiment the codebook 104a is a conventional one-time codebook 104a. A server 106 is provided which includes a database 108. The database 108 also contains a one-time codebook 104b, which corresponds to the one-time codebook 104a of the machine 102. The one-time codebook can preferably take the form of a microprocessor that can be removed from either the machine or the database and replaced. A wireless device 110, such as a personal data assistant (PDA), cell phone, laptop, notebook, etc., is utilized to facilitate the purchase of a product or service from the machine 102. Although the machine 102 is shown for purposes of simplicity, one of ordinary skill readily recognizes that a plurality of machines that have codebooks and receivers therewithin could be utilized and their use would be within the spirit and scope of the present invention. To describe the cooperation of these elements, refer now to the following.

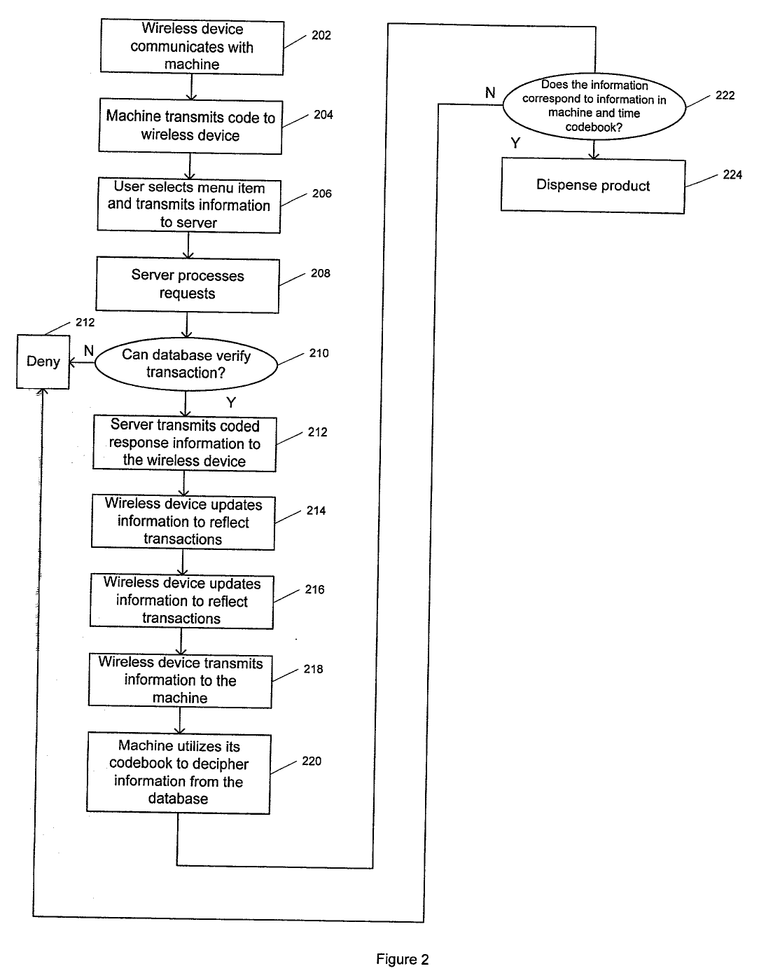

FIG. 2 is a flow chart of the operation of the system of FIG. 1 in accordance with the present invention. Referring now to FIGS. 1 and 2 together, first a user uses the wireless device 110 to communicate with the machine 102 via, for example, an infrared signal, via step 202. The machine includes a receiver/transmitter 112 that will receive the signal and will issue a code, request ID and a menu of goods available for purchase. The information is then transmitted to the wireless device 111, via step 204. The user then selects a menu item and the wireless device will transmit the information related to that menu item (i.e., a particular soda) along with the personal identification information of the user (which may include an electronic signature and/or a personal identification number) to the server 106, via step 206. The server 106 will preferably be a secure server that can be accessed by a web browser on an open network, such as the world-wide web. The server 106 will process the request, via step 208. This process will comprise in a preferred embodiment looking up a one time code from the one time code book 104b for the specific ID of the machine 102 in the database 108. The server 106 will then verify the user's personal identification information to authorize or deny the transaction, via step 210. If the database 108 cannot decipher the coded information, it will deny the transaction, via step 212. The database 108 will also in a preferred embodiment review the personal identification information alone or with other databases to approve or deny the requested transaction.

If the database verifies the transaction, the server 106 will then transmit the coded response information with the personal identification information to the wireless device 110, via step 214. The wireless device 110 will then update the personal identification information to reflect the transaction via step 216 and will transmit the coded response information to the machine 102, via step 218. The machine will utilize the one time codebook 104a to decipher information from the database, via step 220. Next the machine determines if the information is valid, via step 222.

If the machine determines that either the transaction is denied or the coded response information does not correspond with the information in its One Time Code Book 104a, then the machine will transmit information to the wireless device that the transaction is not approved, via step 212. If on the other hand, if the transaction is approved the machine 102 will dispense the requested product, via step 224. In a further improvement to the above-identified invention, the one-time codebooks 104a and 104b can be periodically synchronized between the machine and the database.

Through the use of codebooks in the machine and the database and the use of a receiver/transmitter in the machine, a wireless device could be utilized advantageously to provide secure micropayments to the vending machine. This type of system would not require a significant expenditure or infrastructure and would not require a proprietary network for its implementation. Therefore, a system and method in accordance with the present invention would allow for an effective and efficient way to provide such secure micropayments.

Although the present invention has been described in accordance with the embodiments shown, one of ordinary skill in the art will readily recognize that there could be variations to the embodiments and those variations would be within the spirit and scope of the present invention. For example, although one time codebooks are described one of ordinary skill in the art readily recognizes that many types of codebooks could be utilized and their use would be within the spirit and scope of the present invention. Also, one recognizes that vending machines are described in the context of the present invention, one of ordinary skill in the art readily recognizes that any type of machine that will accept micropayments for goods or services could be utilized in accordance with the present invention, and that use would be within the spirit and scope of the present invention.

Accordingly, many modifications may be made by one of ordinary skill in the art without departing from the spirit and scope of the appended claims.

What is claimed is:

1. A method for providing a micropayment to a machine for providing goods or services utilizing a wireless device, the method comprising the steps of:
(a) selecting an item to be purchased from the machine by the wireless device;
(b) providing a code related to the item from the machine to the wireless device;
(c) transmitting a request including the code to a server;
(d) transmitting a response to the request to wireless device if the request is valid;
(e) transmitting the request to the machine; and
(f) dispensing a product if the machine determines that response is valid based upon the code.

2. The method of claim 1 wherein the code is from a one-time codebook.

3. The method of claim 2 wherein each of the database and the machine include corresponding one-time codebooks.

4. The method of claim 3 wherein the request includes personal identification information.

5. The method of claim 1 wherein the selecting step (a) further comprises the steps of:
(a1) providing a signal from the wireless device to the machine to communicate therewith; and
(a2) transmitting a code, request ID and a menu of goods available for purchase from the machine to the device to allow for the selection of an item to be purchased.

6. A secure micropayment system comprising:
a wireless device for providing requests;
a machine for providing products based upon receipt of a micropayment; the machine including a receiver for receiving and a transmitter for receiving and transmitting requests;
a first codebook; and
a server for communicating with the wireless device and the machine; the server including a datgabase, the database further including a second codebook, wherein the first and second codebooks are utilized to ensure that purchase of goods via the micropayment is valid.

7. The secure micropayment system of claim 6 wherein the first and second codebooks each comprises a one time codebook.

8. The secure micropayment system of claim 6 wherein the wireless device selects an item to be purchased from the machine responsive to the selection and the machine provides a code from the codebook related to item to the wireless device.

9. The secure micropayment system of claim 8 wherein the receiver/transmitter transmits a request including the code to the server.

10. The secure micropayment system of claim 9 wherein the server transmits a response to the request to the wireless device if the request is valid and the wireless device transmits the valid request to the machine and wherein a product is dispensed if the request is valid based upon the code.

11. A computer readable medium containing program instructions for providing a micropayment to a machine for providing goods or services utilizing a wireless device, the program instructions for:
(a) selecting an item to be purchased from the machine by the wireless device;
(b) providing a code related to the item from the machine to the wireless device;
(c) transmitting a request including the code to a server;
(d) transmitting a response to the request to wireless device if the request is valid;
(e) transmitting the request to the machine; and
(f) dispensing a product if the machine determines that response is valid based upon the code.

12. The computer readable medium of claim 11 wherein the code is from a one-time codebook.

13. The computer readable medium of claim 12 wherein each of the database and the machine include corresponding one-time codebooks.

14. The computer readable medium of claim 13 wherein the request includes personal identification information.

15. The computer readable medium of claim 11 wherein the selecting step (a) further comprises the steps of:
(a1) providing a signal from the wireless device to the machine to communicate therewith; and
(a2) transmitting a code, request ID and a menu of goods available for purchase from the machine to the device to allow for the selection of an item to be purchased.
